(19) United States
(12) Patent Application Publication
(10) Pub. No.: US 2009/0041312 A1
(43) Pub. Date: Feb. 12, 2009

(54) IMAGE PROCESSING APPARATUS AND METHOD

(75) Inventor: Tomokazu Wakasugi, Tokyo (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/186,916

(22) Filed: Aug. 6, 2008

(30) Foreign Application Priority Data
Aug. 7, 2007 (JP) 2007-205185

(51) Int. Cl. G06K 9/00

(52) U.S. Cl. 382/118

(57) ABSTRACT

An image processing apparatus includes a unit configured to detect face areas from frames of an input moving image; a unit configured to identify face conditions, which vary depending on a face direction, from the face areas; a unit configured to classify the face areas based on the face conditions; a unit configured to correlate, when a moving distance of the face areas between adjacent frames is within a threshold value, the face areas in the frames as one sequence; a unit configured to create dictionaries in which the face areas classified based on the conditions are stored for respective sequences; a unit configured to calculate a degree of similarity between face areas, of the same condition, stored in dictionaries in different sequences, to connect sequences whose degree of similarity is high, and to determine that the face areas belonging to the connected sequences are of the same person.

### CROSS-REFERENCE TO RELATED APPLICATION

This application is based upon and claims the benefit of priority from the prior Japanese Patent Application No. 2007-205185, filed on Aug. 7, 2007; the entire contents of which are incorporated herein by reference.

### FIELD OF THE INVENTION

The present invention relates to an image processing apparatus and method which, in a technology classifying moving images into appearance scenes of each individual performer, by identifying conditions of faces of the performers and calculating degrees of similarity between the faces for each condition, can prevent a deterioration in an identification performance due to a variation of a face direction, a facial expression or the like.

### DESCRIPTION OF THE BACKGROUND

As a method for efficiently viewing image (moving image) contents of a television program or the like, a method can be considered which detects faces in the image and, by matching faces of the same person, classifies moving images according to the appearance scenes of each individual performer.

For example, in a case of a song program in which a large number of singers appear, as long as the whole of the program is classified as appearance scenes of the individual singers, a viewer, by cueing each singer's performance scenes one after another, can only view a favorite singer efficiently.

Meanwhile, as a person in the image has various face directions and facial expressions, there is a problem in that a variation thereof causes a great reduction in a degree of similarity between different scenes of the same person. In order to solve this problem, for example, a method which recognizes a face direction or a facial expression, and creates a dictionary without using a diagonally directed face or a smiling face was proposed (see, for example, JP-A-2001-167110 (Kokai)). However, according to this method, all scenes having only the diagonally directed or smiling face are eliminated.

When a user of an image indexing attempts to view a certain person's scenes, the user may try to view scenes other than the scenes of a frontally directed face. Consequently, with a method of eliminating a diagonally directed face, it is impossible to sufficiently fulfill the user's demand. Also, a method which corrects the diagonally directed face to the frontally directed face, or the like, was also proposed (see, for example, JP-A-2005-227957 (Kokai)). However, this is not sufficiently effective because it is difficult to reliably detect facial feature points from the diagonally directed face, or the like.

As described, in a case of using the conventional technology, there has been a problem in that the diagonally directed face or smiling face is not included in a scene of a person designated by the user.

### SUMMARY OF THE INVENTION

Accordingly, an advantage of an aspect of the present invention is to provide an image processing apparatus which, when creating a dictionary of one certain person, can create it even in the event that a face direction, a facial expression or the like varies.

To achieve the above advantage, one aspect of the present is to provide an image processing apparatus including a face detection unit configured to detect face areas from images of respective frame of an input moving image; a face condition identification unit configured to identify face conditions, which vary depending on a face direction, a facial expression or a way of shedding light on a face, from images of the face areas; a face classification unit configured to classify the face areas based on the face conditions; a sequence creation unit configured to correlate, when the face areas satisfy the condition that a moving distance of the face areas between adjacent frames is within a threshold value, the face areas in the frames as one sequence; a dictionary creation unit configured to, using image patterns of the face areas classified based on the conditions, create dictionaries for respective sequences; a face clustering unit configured to calculate a degree of similarity between the dictionaries, created using the image patterns of the face areas in different sequences, for each condition, to connect sequences whose degree of similarity therebetween is high, and to determine that the face areas belonging to the connected sequences are of a face of the same person.

### BRIEF DESCRIPTION OF THE DRAWINGS

FIG. 1 is a diagram showing a configuration of an image processing apparatus according to a first embodiment of the invention;

FIG. 2 is a flowchart showing an operation;

FIG. 3 is an illustration of a sequence;

FIG. 4 is a diagram of one example of sequences in a scene in which two persons appear;

FIG. 5 is a diagram of one example of a sequence including a plurality of face directions;

FIG. 6 is a conceptual diagram of a subspace dictionary and a mean vector dictionary;

FIGS. 7A-7C are diagrams representing three methods of calculating a degree of similarity between two dictionaries;

FIG. 8 is a diagram of one example of three sequences in which face direction configurations differ;

FIGS. 9A-9C are diagrams showing calculation methods when calculating degrees of similarity between three sequences in FIGS. 7A-7C;

FIG. 10 is a diagram showing a method of calculating degrees of similarity between sequences each configured of a plurality of face direction dictionaries;

FIG. 11 is a block diagram showing a configuration of an image processing apparatus according to a second embodiment; and

FIG. 12 is a diagram showing 18 kinds of face image folder labeled by face directions and facial expressions.

### DETAILED DESCRIPTION OF THE INVENTION

### First Embodiment

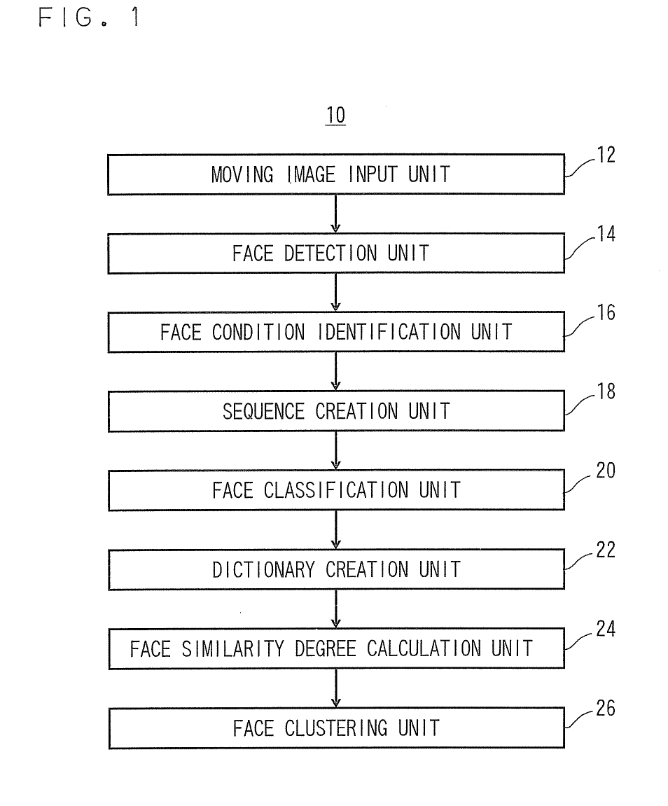

A first embodiment in accordance with the present invention will be explained with reference to FIGS. 1 to 10.

FIG. 1 is a block diagram showing image processing apparatus 10 according to the embodiment.

Image processing apparatus 10 includes a moving image input unit 12 which inputs a moving image, a face detection unit 14 which detects a face from each frame of the input moving image, a face condition identification unit 16 which identifies conditions of the detected faces, a sequence creation unit 18 which creates sequences using a temporally and positionally continuous series of faces from among all the detected faces, a face classification unit 20 which, based on obtained face condition information, classifies the faces in the individual frames into the conditions, a dictionary creation unit 22 which creates each condition's face image dictionaries for each sequence, a face similarity degree calculation unit 24 which, using the created dictionaries, calculates degrees of face image similarity for each condition, and a face clustering unit 26 which, using degrees of similarity between the face image dictionaries, groups individual scenes in the moving image. The moving image input unit 12 may be arranged outside of the image processing apparatus 10.

The above mentioned function of each unit 12 to 26 can also be realized by a program stored in a computer readable medium.

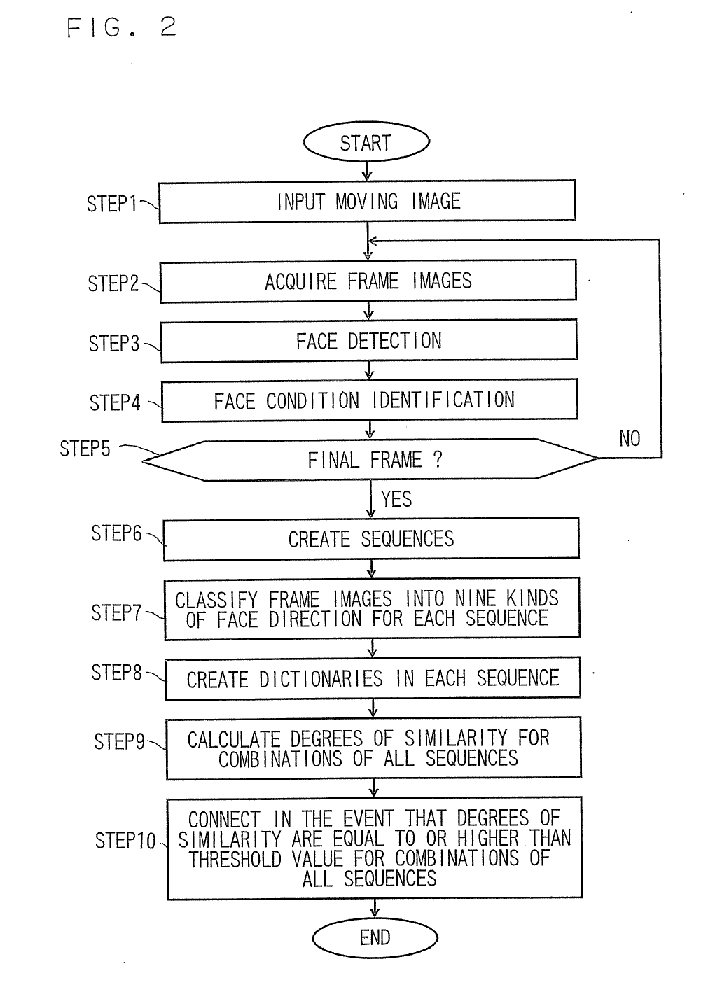

Hereinafter, with reference to FIGS. 1 and 2, a description will be given of an operation of image processing apparatus 10. FIG. 2 is a flowchart showing the operation of image processing apparatus 10.

Moving image input unit 12 inputs a moving image using a method such as loading it from an MPEG file (step 1), extracts image of each frame, and transmits the image to face detection unit 14 (step 2).

Face detection unit 14 detects face areas from the images (step 3), and transmits images and face position information to face condition identification unit 16.

Face condition identification unit 16 identifies conditions of all the faces detected by face detection unit 14 (step 4), and provides a condition label to each face.

In the embodiment, a face direction is used as one example of the “face condition.” Face direction labels use nine directions (front, up, down, left, right, upper left, lower left, upper right and lower right), including a front.

Firstly, six points (i.e., both eyes, both nostrils and both mouth corners) are detected as feature points of a face, and it is determined, from their positional relationship, which of the nine face directions the face corresponds to, using a factorization method.

A method of determining a face direction from a positional relationship of facial feature points is disclosed in “Face Direction Estimation by Factorization Method and Subspace Method” by Yamada Koki, Nakajima Akiko and Fukui Kazuhiro, Institute of Electronics, Information and Communication Engineers, Technical Research Report PRMU 2001-194, pp. 1-8, 2002 or the like. That is, as a method of identifying a face direction, a plurality of face direction templates are created in advance using face images of various directions, and a face direction is determined by obtaining a template of a highest degree of similarity from among the face direction templates.

The face direction label of each face identified in face condition identification unit 16 in this way is transmitted to face classification unit 20 as face direction information.

The process of steps 2 to 4 is repeatedly executed until a final frame of input image contents is reached (step 5).

Sequence creation unit 18 classifies all the detected faces into individual sequences (step 6).

Firstly, in the embodiment, conditions of temporal and positional continuity are defined as in “a.” to “c.” below, and a series of faces which fulfills these three conditions is taken as one “sequence.”

a. A center to center distance between face areas in a current frame is sufficiently approximate to that between face areas in the previous frame, that is, equal to or shorter than a reference distance.

b. A size of the face areas in the current frame is sufficiently approximate to that of the face areas in the previous frame, that is, within a predetermined range.

c. There is no scene switching (cut) between the face areas in the current frame and the face areas in the previous frame. Herein, in a case in which a degree of similarity between two continuous frame images is a threshold value or smaller, an interval between the two frames is taken as a scene switching (cut).

It is for the following reason that the condition c is added to the continuity conditions. In image contents of a television program, a movie and the like, there is a case in which, immediately after a scene in which a certain person appears has switched, a different person appears in almost the same place. In this case, the two persons straddling the scene switching are regarded as the same person. In order to solve this problem, a scene switching is detected, and sequences straddling the scene switching are always divided thereby.

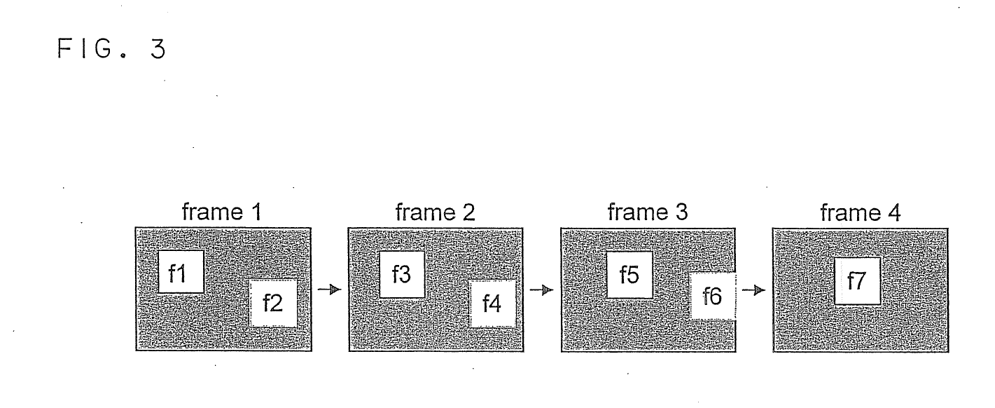

A description will be given of one example of a face detection result, which is shown in FIG. 3. FIG. 3 represents a case in which two, two, two and one faces have been detected in order in four continuous frames. As faces f1, f3, f5 and f7 fulfill the above mentioned continuity conditions, they are one sequence.

Also, as faces f2, f4 and f6 also fulfill the continuity conditions in the same way, they are one sequence.

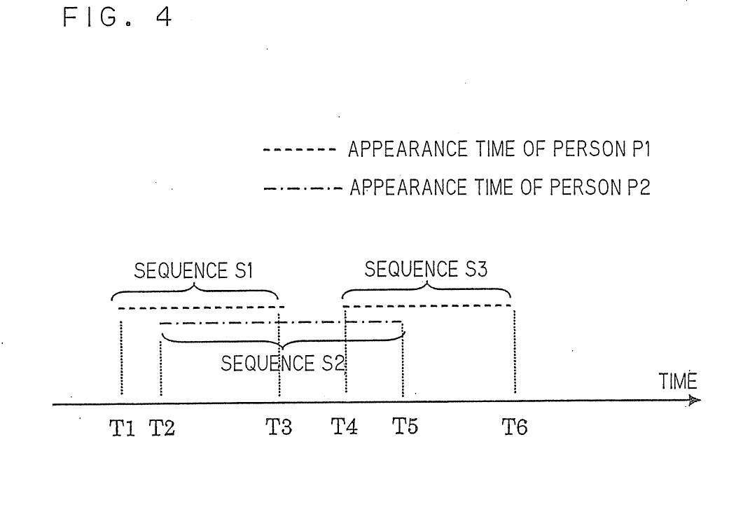

Next, a description will be given of one example of sequences of times T1 to T6 in a scene in which two persons P1 and P2 appear, which is shown in FIG. 4. Although no person is specified at this point, in order to facilitate description, a description will be given with the persons P1 and P2.

Firstly, the person P1 appears (time T1).

Immediately after that, the person P2 appears (time T2).

After a while, as the person P1 has turned his or her back, his or her face becomes undetectable (time T3). At this point, a range (times T1 to T3) of a sequence S1 of the person P1 is determined.

Subsequently, the person P1 restores the original frontal direction immediately (time T4).

However, some time later, the person P2 disappears from a screen this time (time T5). At this point, a sequence S2 of the person P2 is determined.

Finally, the person P1 also disappears from the screen (time T6), and a sequence S3 is determined.

Although it is difficult, using a current computer vision technology, to judge whether faces of different directions are of the same person, by using a tracking as in the embodiment, it is possible to relatively easily determine whether or not faces of different directions are of the same person.

Sequence creation unit 18, based on the face position information transmitted from face detection unit 14, carries out the above mentioned kind of sequence creation process for the whole of the image contents, and transmits sequence range information representing the created range of each sequence to face classification unit 20.

Face classification unit 20, based on the face direction information transmitted from face condition identification unit 16, and on the sequence range information transmitted from sequence creation unit 18, creates a normalized face image from the faces detected in the individual sequences, and classifies it as one of the nine face directions (step 7).

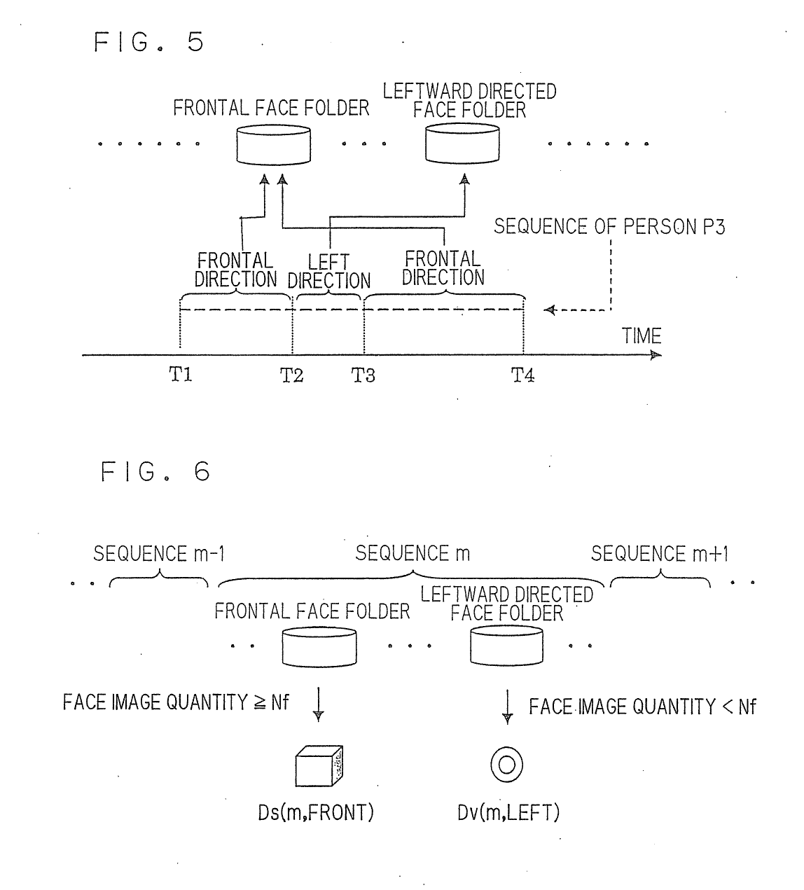

FIG. 5 represents a sequence in which a certain person P3 appears. A face of the person P3 is detected at time T1 and, after that, continues to be continuously detected until time T4. During that time, the person P3 faces to the left once at time T2, and restores the frontal direction again at time T3.

In this case, face classification unit 20 firstly stores a frontally directed face image between times T1 and T2 in a frontal face folder among face image folders corresponding to the nine face directions.

Next, face classification unit 20 stores a leftward directed face image between time T2 and T3 in a leftward directed face folder.

Finally, face classification unit 20 stores a frontally directed face image between times T3 and T4 in the frontal face folder.

By so doing, the face images stored in the folders for each sequence in face classification unit 20 are transmitted to dictionary creation unit 22. The folders are generated for each sequence, and one for each face. That is, in the event that two frontally directed faces exist in a certain frame of the sequence S1, two frontal face folders are generated.

Dictionary creation unit 22, using the face images transmitted from face classification unit 20, creates a face image dictionary for each of the nine face directions in each sequence (step 8).

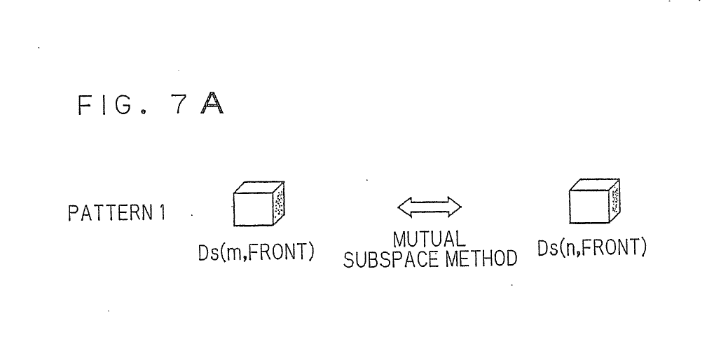

Hereafter, a description will be given, while referring to FIG. 6, of a method of creating a face image dictionary relating to an mth sequence.

It being assumed that a sequence m in FIG. 6 is identical to the sequence of the person P3 in FIG. 5, it is taken that the face images are stored only in the frontal face folder and the leftward directed face folder, among the folders corresponding to the nine face directions. Also, FIG. 6 represents a case in which, a number of frontally directed face images being Nf or more, a number of leftward directed face images is one or more, and less than Nf, and with regard to the other seven face directions, a number of face images of each set is zero.

First, a number of face images stored in the frontal face folder is counted.

Secondly, as the number of frontally directed face images is Nf or more, by analyzing principal components of the face images stored in the folder, a subspace dictionary Ds(m, front) is created. At this time, it is also acceptable to use all the frontal face images stored in the frontal face folder, and it is also acceptable to use one portion of the frontal face images included in the folder. However, Nf or more is always secured. A dimension number of a subspace dictionary created at this time is Nf.

Thirdly, a number of face images stored in the leftward directed face folder is counted.

Fourthly, as the number of leftward directed face images is one or more, and less than Nf, a mean vector of the leftward directed face images stored in the folder is taken as a mean vector dictionary Dv(m, left).

The reason for using two kinds of dictionary is that the subspace dictionary tends to have an unreliable result in the event that there is a smaller number of face images. Nf is a parameter on which a designer of image processing apparatus 10 can decide appropriately.

It is also possible to carry out a preprocessing with a filter or the like which suppresses an illumination variation before the principal component analysis of the face images, or the conversion thereof into the mean vector.

All the face image dictionaries created by dictionary creation unit 22 in this way are transmitted to face similarity degree calculation unit 24.

Face similarity degree calculation unit 24 calculates degrees of similarity between the face image dictionaries transmitted from dictionary creation unit 22 (step 9).

The similarity degree calculation is carried out by comparing all the sequences with all the others. A degree of similarity Sim(m, n) between the mth and an nth sequence is defined by Equation (1) shown below as a maximum value of a degree of similarity Sim(m, n, f) between both sequences relating to the nine face directions.

Sim(m,n)=Max(Sim(m,n,f)) (1)

Herein, f represents one of the nine face directions.

In the event that one of the mth and nth sequences dose not have a dictionary of the face direction f, Sim(m, n, f) is taken as 0.

Hereafter, for the sake of simplicity, a description will be given of three patterns of a case in which all the sequences are configured only of the frontally directed face.

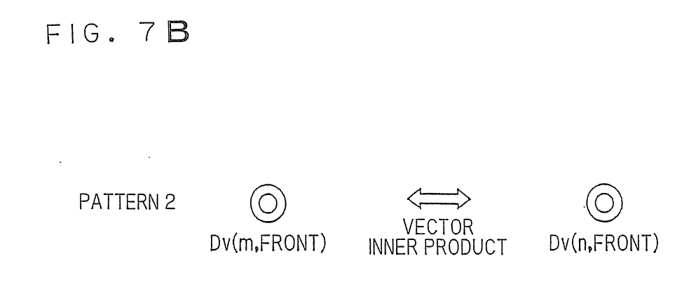

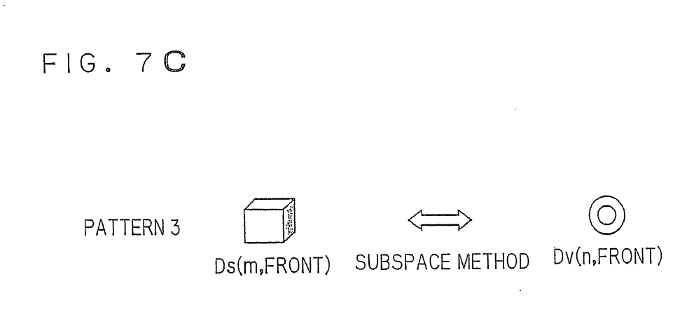

FIGS. 7A-7C represent three patterns of a case of calculating a degree of similarity between two dictionaries.

A first pattern is a case in which both the two dictionaries are subspaces (FIG. 7A). In this case, the degree of similarity is calculated by means of a mutual subspace method (see “Face Recognition System Using Moving Image” by Yamaguchi Osamu, Fukui Kazuhiro and Maeda Kenichi, Institute of Electronics, Information and Communication Engineers, Technical Research Report PRMU 97-50, pp. 17-24, (1997)). Herein, Ds(m, front) represents a subspace dictionary of a frontally directed face image in the mth sequence.

A second pattern is a case in which both the two dictionaries are mean vectors (FIG. 7B). In this case, an inner product of vectors is taken as the degree of similarity. Herein, Dv(m, front) represents a mean vector dictionary of the frontally directed face image in the mth sequence.

A third pattern is a case of a subspace and a mean vector (FIG. 7C). In this case, the degree of similarity can be calculated by means of a subspace method (see “Pattern Recognition and Subspace Method” by Erkki Oja, Sangyo Tosho Publishing Co., Ltd. (1986)) (pattern 3).

In the description so far, it has been taken that the mean vector dictionary is created in the event that the number of face images is less than Nf, but a method can also be considered which creates the subspace dictionary even in the event that the number of face images is less than Nf, rather than using the mean vector.

Next, a description will be given of a case in which each sequence also includes a face of other than the frontal direction.

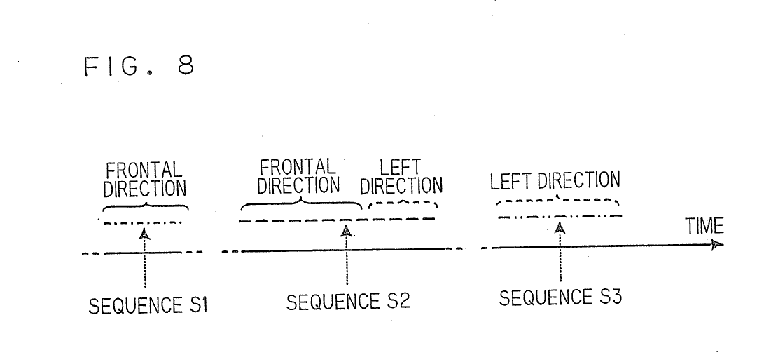

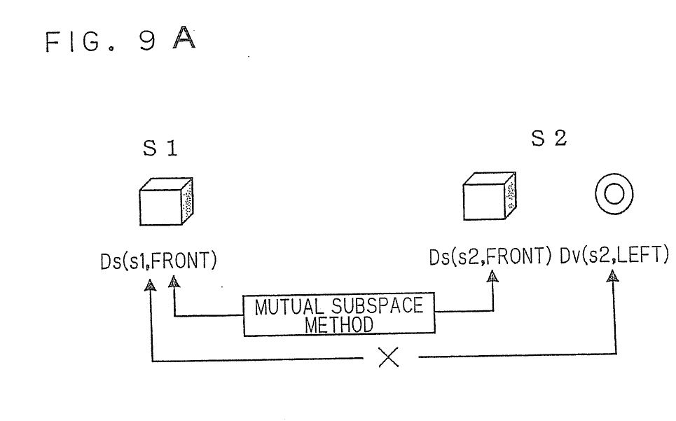

FIG. 8 represents three different sequences S1, S2 and S3 configured of only the frontal direction, the frontal direction and the left direction, and only the left direction, respectively.

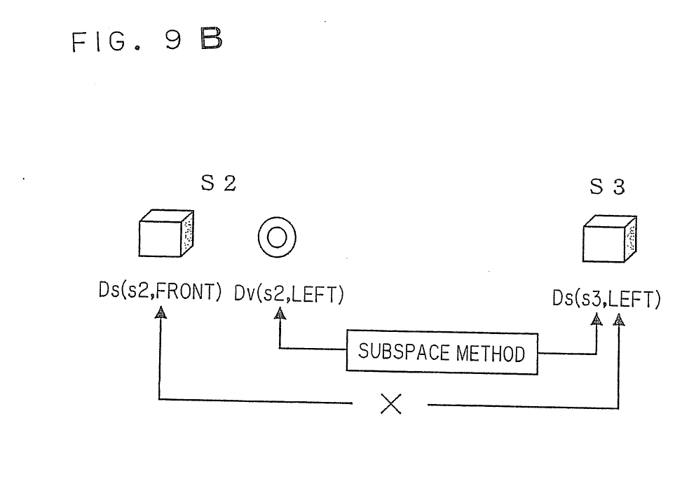

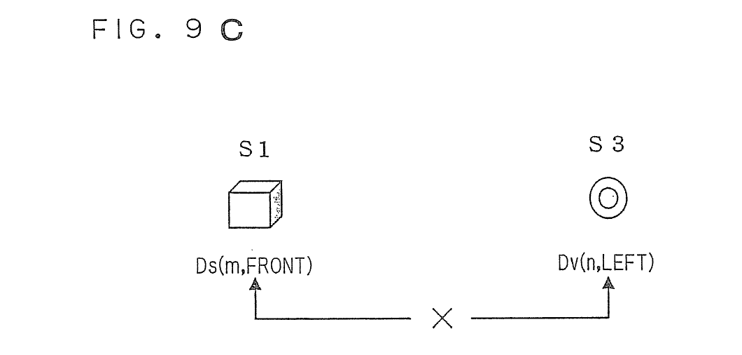

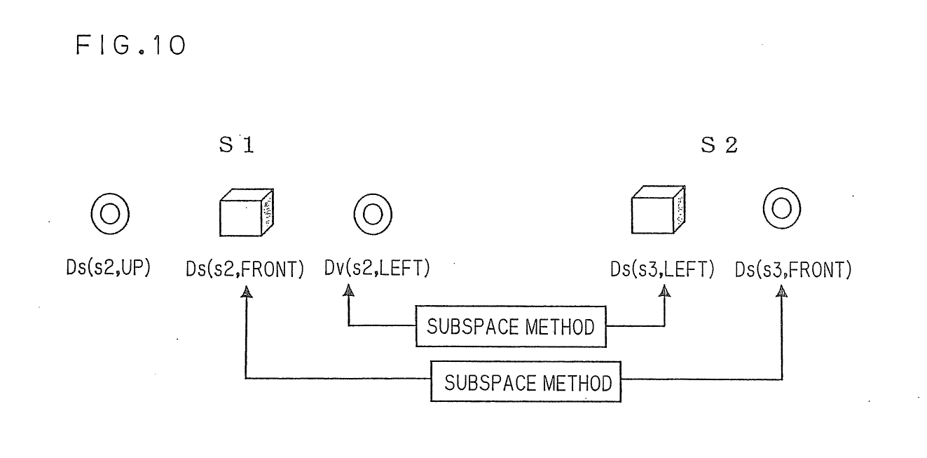

FIGS. 9A-C show a calculation method when calculating degrees of similarity between the three sequences of FIG. 8.

As the sequence S1 and the sequence S2 have frontal direction subspace dictionaries Ds(s1, front) and Ds(s2, front), respectively, a degree of similarity Sim(s1, s2) between the sequence S1 and the sequence S2 can be calculated, using the mutual subspace method, as the degree of similarity between those subspaces (FIG. 9A).

Although the sequence S2 also has a mean vector Dv(s2, left), as the face direction thereof is different from that of the subspace dictionary Ds(s1, front) in the sequence S1, no similarity degree calculation is carried out.

As both the sequences S2 and S3 have the leftward directed face dictionaries, a degree of similarity Sim(s2, s3) between the sequence S2 and the sequence S3 can be calculated, using the subspace method, as a degree of similarity between Dv(s2, left) and Ds(s3, left) (FIG. 9B).

With regard to a subspace dictionary Ds(s2, front) of the sequence S2 and a mean vector Ds(s3, left) of the sequence S3, as the face directions are different, no similarity degree calculation is carried out.

Finally, as the sequence S1 and the sequence S3 do not have the same face direction dictionary, a degree of similarity Sim(s1, s3) between the sequence S1 and the sequence S3 becomes 0 (FIG. 9C).

In a conventional method, as one dictionary is created from one sequence, a dictionary of the sequence S2 is created from a face image in which are mixed the frontal direction and the left direction. Consequently, even in the event that the sequence S1 and the sequence S2 are of the same person, a degree of similarity between the sequence S1, configured only of the frontally directed face, and the sequence S2 becomes lower in comparison with a case of two sequences of frontal directions. As a result of this, the sequence S1 and the sequence S2, in spite of being of the same person, become more likely to be regarded as being of different persons and, in some cases, it is just conceivable that all the three sequences are determined to be of different persons.

On the other hand, according to the embodiment, as the degree of similarity between the sequence S1 and the sequence S2 is calculated using only the frontally directed face, and the degree of similarity between the sequence S2 and the sequence S3 is calculated using only the leftward directed face, the above mentioned kind of problem of a deterioration in an identification performance due to a mixing of different face directions does not occur.

Finally, a description will be given of a similarity degree calculation method in a case in which each of the two sequences is configured of a plurality of face directions.

FIG. 10 represents dictionaries of a sequence S1 configured of the up direction, the frontal direction and the left direction, and a sequence S2 configured of the frontal direction and the left direction.

Although the sequence S1 has three face direction dictionaries, and the sequence S2 has two face direction dictionaries, as there are only two kinds of shared face direction, the frontal direction and the left direction, a degree of similarity Sim(s1, s2) between the sequence S1 and the sequence S2 is calculated by Equation (1) as a value of whichever is greater, Sim(s1, s2, front) or Sim(s1, s2, left).

The degrees of similarity calculated comparing all the sequences with all the others in this way in face similarity degree calculation unit 24 are transmitted to face clustering unit 26.

Face clustering unit 26 receives the degrees of similarity between the sequences calculated by face similarity degree calculation unit 24 and, based on that information, carries out a connection of sequences (step 10).

Supposing that Ns sequences are created in sequence creation unit 18, the following process is carried out for K=Ns(Ns−1)/2 combinations.

That is, when Sim(m, n)=>Sth, the mth and nth sequences are connected.

Herein, m and n are sequence numbers (1<=m, n<=Ns), and Sth a threshold value. By carrying out this process for K combinations, sequences of the same persons are connected.

A description will be given of a case of executing an image indexing as an application.

Firstly, an aspect can be considered in which the process described in the embodiment is carried out for image contents which are objects, a list of top P characters in a decreasing order of appearance time is displayed by means of thumbnail face images and, by clicking a certain thumbnail face image, it is possible to view only scenes in which a corresponding person appears.

At this time, it is desirable for a user that appearance scenes (sequences) of individual persons are as clustered as possible. As above mentioned, with the conventional method, in the event that different face directions are mixed, as the degree of similarity between identical persons is reduced, the appearance scenes of each person remain divided into a plurality of groups. In this case, a problem occurs in that a plurality of identical persons are included in the list of the top P characters, and furthermore, bottom characters in the list are likely to be left off of the list. On the other hand, according to the embodiment, as it is possible to prevent the reduction in the degree of similarity between the identical persons due to the mixing of face directions, that kind of problem is unlikely to occur.

### Second Embodiment

A second embodiment in accordance with the present invention will be explained with reference to 11 and 12.

In the first embodiment, a description has been given of a case of using the face directions as the face conditions. In this embodiment, a description will be given of a case of using a plurality of kinds of face condition. Specifically, face directions and facial expressions are used as the plurality of kinds of face condition.

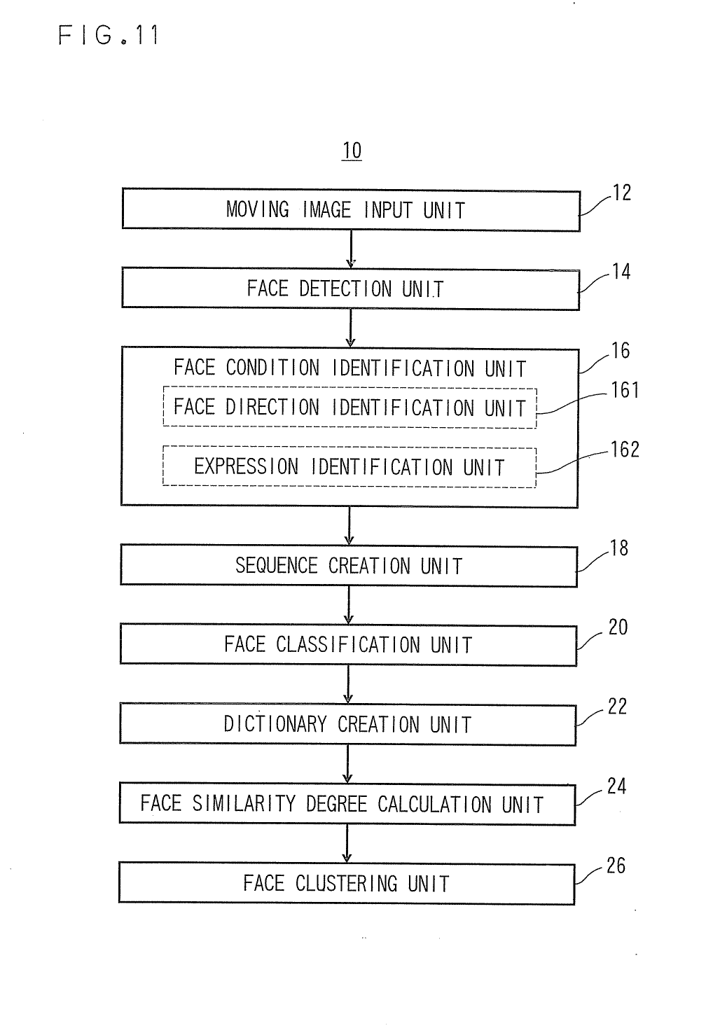

FIG. 11 is a block diagram showing image processing apparatus 10 according to this embodiment. A difference from the first embodiment is that face condition identification unit 16 is configured of two units, a face direction identification unit 161 and an expression identification unit 162.

As an outline of a processing flow in this embodiment is the same as that of the first embodiment, a flowchart relating to this embodiment will be omitted.

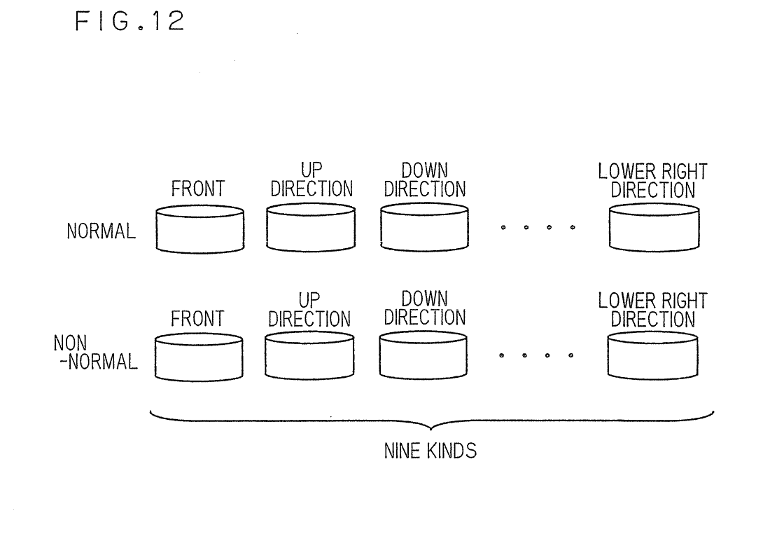

Hereafter, a description will be given, with reference to FIGS. 11 and 12, of an operation of image processing apparatus 10 according to this embodiment.

As many processes in this embodiment duplicate those of the first embodiment, in the following description, a description will be given focused on a difference from the first embodiment.

A moving image input unit 12 inputs a moving image by means of a method loading it from an MPEG file, or the like (step 1), retrieves each frame's images, and transmits them to a face detection unit 14 (step 2).

Face detection unit 14 detects face areas from the image (step 3), and transmits images and face position information to a face condition identification unit 16 and a sequence creation unit 18.

Face condition identification unit 16 identifies all the face conditions (face directions and expressions) detected by face detection unit 14 (step 4), and gives condition labels of the face direction and expression to each face.

In the same way as in the first embodiment, face direction labels are taken to use nine directions (front, up, down, left, right, upper left, lower left, upper right and lower right), including a front. As the face direction identification method has already been described in the first embodiment, it will be omitted here.

Two kinds of expression label are used, a “normal” label and a “non-normal” label. The non-normal label is a label representing a condition in which, in a smile or the like, an expression differs greatly from an expressionless face, and the normal label represents other conditions. Specifically, an open or closed condition of lips being recognized by means of an image processing, a case in which the lips open for a certain time or longer is taken as a non-normal condition, and other cases as a normal case.

In this way, in the face condition identification unit 16, the face direction label and expression label of each identified face are transmitted to a face classification unit 20 as face condition information.

The process of steps 1 to 4 is repeatedly executed until a final frame of the input image contents is reached (step 5).

In this embodiment, in the same way as the first embodiment, a temporally and positionally continuous series of faces is handled as one sequence.

Sequence creation unit 18 classifies all the detected faces into sequences (step 6). Details of the sequence creation method will be omitted here as they have been described in the first embodiment. Information representing a range of each sequence created from all the image contents is transmitted to face classification unit 20.

Face classification unit 20, based on the face direction information transmitted from face condition identification unit 16, and on the sequence range information transmitted from sequence creation unit 18, creates a normalized face image from the faces detected in the individual sequences, and classifies it as one of 9 kinds (face direction)×2 kinds (expression)=18 kinds of condition (step 7).

FIG. 12 represents image folders corresponding to 18 kinds of condition label. Each sequence has these 18 kinds of folder.

The normalized face images stored in the 18 kinds of folders for each sequence are sent to a dictionary creation unit 22.

Dictionary creation unit 22, using the normalized face images transmitted from face classification unit 20, creates a face image dictionary for each of the 18 kinds of face condition in each sequence (step 8).

A number of normalized face images of a condition t in an mth sequence is takes as N(m, t) In the event that N(m, t) is Nf or more, a subspace dictionary Ds(m, t) is created by analyzing principal components of the face images stored in the folders. At this time, it is also acceptable to use all the face images stored in a frontal face folder and, in the event that N(m, t) is Nf or more, it is also acceptable to use one portion of the face images included in the folders.

In the event that a number of normalized face images of the condition t in the mth sequence is one or more, and less than Nf, a mean vector of the face images stored in the folders is taken as a mean vector dictionary Dv(m, t).

All the created face image dictionaries are transmitted to a face similarity degree calculation unit 24.

Face similarity degree calculation unit 24 calculates degrees of similarity between the face image dictionaries transmitted from dictionary creation unit 22 (step 9).

The similarity degree calculation is carried out comparing all the sequences with all the others. A degree of similarity between the mth and an nth sequence Sim(m, n) is defined by Equation (2) shown below as a maximum value of a degree of similarity Sim(m, n, t) relating to the 18 kinds of condition.

Sim(m,n)=Max(Sim(m,n,t)) (2)

Herein, t represents one of the 18 kinds of condition.

In the event that one of the mth and nth sequences has no dictionary of the condition t, Sim(m, n, t) is taken as 0.

The degrees of similarity calculated comparing all the sequences with all the others in face similarity degree calculation unit 24 are transmitted to a face clustering unit 26.

Face clustering unit 26 receives the degrees of similarity between the sequences calculated by face similarity degree calculation unit 24 and, based on that information, carries out a connection of the sequences (step 10).

It being supposed that Ns sequences have been created in sequence creation unit 18, the following process is carried out for K=Ns(Ns−1)/2 combinations.

That is, when Sim(m, n)=>Sth, the mth and nth sequences are connected.

Herein, m and n are sequence numbers (1<=m, n<=Ns), and Sth a threshold value.

By carrying out this process for K combinations, sequences of the same person are connected.

### Modification Examples

The invention, not being limited to each above mentioned embodiment, can be modified variously without departing from the scope thereof.

In the above mentioned embodiments, the face directions and expressions are used as the face conditions, but it is also possible to implement the invention using another face condition, such as a way of shedding light (for example, an illumination) on a face.

Also, as a tracking method for creating sequences in sequence creation unit 18, apart from the above mentioned three conditions, it is also possible to carry out a matching using clothes of performers, or a tracking using motion information or the like of an optical flow or the like.

Also, the invention, not being limited to the above mentioned embodiments as they are, in its implementation phase, can be embodied by modifying the components without departing from the scope thereof. Also, various inventions can be formed by means of an appropriate combination of the plurality of components disclosed in the above mentioned embodiments. For example, it is also acceptable to delete some components from all the components shown in the embodiments.

What is claimed is:

1. An image processing apparatus comprising:
a face detection unit configured to detect face areas from images of respective frames of an input moving image;
a face condition identification unit configured to identify face conditions, which vary depending on a face direction, a facial expression or a way of shedding light on a face, from images of the face areas;
a face classification unit configured to classify the face areas based on the face conditions;
a sequence creation unit configured to correlate, when the face areas satisfy the condition that a moving distance of the face areas between adjacent frames is within a threshold value, the face areas in the frames as one sequence;
a dictionary creation unit configured to, using image patterns of the face areas classified based on the conditions, create dictionaries for respective sequences;
a face clustering unit configured to calculate a degree of similarity between the dictionaries, created using the image patterns of the face areas in different sequences, for each condition, to connect sequences whose degree of similarity therebetween is high, and to determine that the face areas belonging to the connected sequences are of a face of the same person.

2. The apparatus according to claim 1, wherein
the face condition identification unit extracts lips from the face areas, recognizes an open or closed condition of the lips and, based on the open or closed condition, identifies the facial expression.

3. The apparatus according to claim 2, wherein
the sequence creation unit correlates, when the face areas satisfy, in addition to the condition, the condition that a difference in a size of the face areas in the respective frames is within a predetermined range, the face areas of the respective frames as the one sequence.

4. The apparatus according to claim 2, wherein
the sequence creation unit correlates, when the face areas satisfy, in addition to the condition, the condition that there is no scene switching between the frames, the face areas of the individual frames as the one sequence.

5. An image processing method comprising steps of:
detecting face areas from images of respective frames of an input moving image;
identifying face conditions, which vary depending on a face direction, a facial expression or a way of shedding light on a face, from images of the face areas;
classifying the face areas based on the face conditions;
correlating, when the face areas satisfy the condition that a moving distance of the face areas between adjacent frames is within a threshold value, the face areas in the frames as one sequence;
creating, using image patterns of the face areas classified based on the conditions, dictionaries for respective sequences;
calculating a degree of similarity between the dictionaries, created using the image patterns of the face areas in different sequences, for each condition, connecting sequences whose degree of similarity therebetween is high, and determining that the face areas belonging to the connected sequences are of a face of the same person.

6. A program product stored in a computer readable medium, comprising the instructions of:
inputting a moving image;
detecting face areas from images of respective frames of an input moving image;
identifying face conditions, which vary depending on a face direction, a facial expression or a way of shedding light on a face, from images of the face areas;
classifying the face areas based on the face conditions;
correlating, when the face areas satisfy the condition that a moving distance of the face areas between adjacent frames is within a threshold value, the face areas in the frames as one sequence;
creating, using image patterns of the face areas classified based on the conditions, dictionaries for respective sequences;
calculating a degree of similarity between the dictionaries, created using the image patterns of the face areas in different sequences, for each condition, connecting sequences whose degree of similarity therebetween is high, and determining that the face areas belonging to the connected sequences are of a face of the same person.
